(19) United States
(12) Patent Application Publication
(10) Pub. No.: US 2021/0326813 A1
(43) Pub. Date: Oct. 21, 2021

(54) Parallel Chain Cross-Chain Transaction Method, Device and Storage Medium

(71) Applicant: JIANGSU FUZAMEI TECHNOLOGY CO., LTD., Suzhou (CN)

(72) Inventors: Zhiwen WANG, Suzhou (CN); Sijin WU, Suzhou (CN)

(21) Appl. No.: 17/272,473

(22) PCT Filed: Aug. 26, 2019
(86) PCT No.: PCT/CN2019/102506

§ 371 Date: Mar. 1, 2021

(30) Foreign Application Priority Data
Aug. 30, 2018 (CN) 201811006311.3
Aug. 26, 2019 (CN) PCT/CN2019/102506

(51) Int. Cl. G06Q 20/02; G06Q 20/36; G06Q 20/38; G06F 16/23

(52) U.S. Cl. CPC G06Q 20/02; G06F 16/2379; G06Q 20/389; G06Q 20/3674

(57) ABSTRACT

The present invention provides a parallel chain cross-chain transaction method, a device and a storage medium. The method includes: receiving a first transaction group; wherein the first transaction group comprising a first transaction on a main chain and a second transaction on a first parallel chain, and the first transaction group being packaged and generated by a matchmaking server or a wallet terminal; confirming an executability of the first transaction and recording the first transaction group onto the main chain, so that each node of the first parallel chain acquires and executes, from a corresponding main chain node, the second transaction, and each verification node of the first parallel chain packages first block information of a first block, wherein the first block information comprising an execution result of the second transaction; receiving the first block information sent by each corresponding verification node of the first parallel chain, and recording same onto the main chain to perform consensus on the first block; and confirming, according to the first block information of the first block passing through the consensus, whether the second transaction has been executed successfully: if so, completing the execution of the first transaction. The present invention provides a cross-chain transaction mechanism between a main chain and a parallel chain.

### BACKGROUND OF THE PRESENT INVENTION

### Field of Invention

The present invention relates to the technical field of cross-chain transaction, and more particularly to a parallel chain cross-chain transaction method, device and storage medium.

### Description of Related Arts

Conventional cross-chain transaction solutions typically employ side chain/relay, hash lock, multi-party computing lock, and etc. For example, BTC Relay is a relatively typical and mature relay application.

The disadvantages of these prior solutions are that, on one hand, when one of the two chains of the cross-chain transaction fails, the transaction executing on the other chain cannot be withdrawn, which is therefore difficult to guarantee the atomicity of the cross-chain transaction and may lead to fund loss of the user; on the other hand, none of these existing solutions provides a cross-chain transaction solution designed for a parallel chain construction, and they are all unsuitable for cross-chain transactions between a main chain and a parallel chain.

### SUMMARY OF THE PRESENT INVENTION

In view of the above deficiencies or drawbacks in the prior art, it is desirable to provide a parallel chain cross-chain transaction method, device and storage medium suitable for cross-chain transactions between a main chain and a parallel chain and further desires to guarantee the atomicity of cross-chain transactions.

In a first aspect, the present invention provides a parallel chain cross-chain transaction method, adapted for a main chain node corresponding to a verification node of a parallel chain, including:

receiving a first transaction group, wherein the first transaction group comprises a first transaction on a main chain and a second transaction on a first parallel chain, packaged and generated through a matchmaking server or a wallet terminal;

confirming an executability of the first transaction and recording the first transaction group onto the main chain, so as for each of the nodes of the first parallel chain to respectively acquire and execute the second transaction from the corresponding main chain node and for each of the verification nodes of the first parallel chain to respectively package a first block information of a first block, wherein the first block information comprises the execution result of the second transaction;

receiving the first block information sent by the corresponding verification nodes of the first parallel chain, and recording same onto the main chain to perform consensus, on the first block; and

confirming, according to the first block information of the first block passing through the consensus, whether the second transaction has been executed successfully: if yes, completing the execution of the first transaction.

In a second aspect, the present invention also provides a parallel chain cross-chain transaction method, adapted for a main chain node corresponding to a non-verification node of a parallel chain, including:

receiving a first transaction group, wherein the first transaction group comprises a first transaction on a main chain and a second transaction on a first parallel chain, packaged and generated through a matchmaking server or a wallet terminal;

confirming the executability of the first transaction and recording the first transaction group onto the main chain, so as for each of the nodes of the first parallel chain to respectively acquire and execute the second transaction from the corresponding main chain node and for each of the verification nodes of the first parallel chain to respectively package and send a first block information of a first block to the corresponding main chain node to record the first block information on the main chain for performing consensus to the first block, wherein the first block information comprises the execution result of the second transaction; and

confirming, according to the first block information of the first block passing through the consensus, whether the second transaction has been executed successfully: if yes, completing the execution of the first transaction.

In a third aspect, the present invention provides a parallel chain cross-chain transaction method, adapted for a verification node of a parallel chain, including:

acquiring and executing a second transaction of a first transaction group from the corresponding main chain node, wherein the first transaction group comprises a first transaction on the main chain and a second transaction on the first parallel chain, packaged and generated through a matchmaking server or a wallet terminal and sent to the main chain node, wherein the first transaction group is recorded onto the main chain when the main chain node received and confirmed the executability of the first transaction; and

packaging and sending the first block information of the first block to the corresponding main chain node to be recorded onto the main chain for performing consensus to the first block, so as for the main chain node to confirm whether the second transaction is executed successfully based on the first block information of the first block with consensus: if yes, completing the execution of the first transaction. Here, the first block information comprises the execution result of the second transaction.

In a fourth aspect, the present invention also provides a device, which includes one or more processors and a storage, wherein the storage includes commands executable by the one or more processors to allow the one or more processors to perform parallel chain cross-chain transaction methods provided in accordance with embodiments of the present invention.

In a fifth aspect, the present invention also provides a storage medium with computer program stored therein so as for allowing a computer to perform a parallel chain cross-chain transaction method provided in accordance with the embodiments of the present invention.

Parallel chain cross-chain transaction methods, devices and storage media provided by the embodiments of the present invention package a first transaction on a main chain and a second transaction on a parallel chain into a transaction group and send it to a main chain node and execute the second transaction on the parallel chain after the executability of the first transaction is confirmed, so as to utilize the consensus mechanism on the parallel chain to confirm the successful execution of the second transaction and then complete the execution of the first transaction on the main chain, thereby providing a secure and reliable cross-chain transaction mechanism suitable for a main chain and a parallel chain;

The parallel chain cross-chain transaction methods, devices, and storage media provided by some embodiments of the present invention further freeze the asset transacted by the first transaction and complete the execution of the first transaction after the second transaction is successfully executed, or undo the freezing operation after the execution of the second transaction has failed, thereby ensuring the atomicity of the asset type cross-chain transaction.

The parallel chain cross-chain transaction methods, devices, and storage media provided by some embodiments of the present invention further execute the first transaction on the main chain beforehand and undo the pre-executed first transaction when the execution of the second transaction has failed, so as to ensure the atomicity of the cross-chain transaction with the undoable main chain transaction.

### BRIEF DESCRIPTION OF THE DRAWINGS

Other features, objects, and advantages of the present application will become more obvious through referring to the detail descriptions of the embodiments that are illustrated in, but not limited by the following figures.

FIG. 1 is an application scenario view of a parallel chain cross-chain transaction according to an embodiment of the present invention.

FIG. 2 is a flow diagram of a parallel chain cross-chain transaction method according to an embodiment of the present invention.

FIG. 3 is a flow diagram of a preferred embodiment of the method of FIG. 2.

FIG. 4 is a flow diagram of another preferred embodiment of the method of FIG. 2.

FIG. 5 is a flow diagram of another parallel chain cross-chain transaction method according to an embodiment of the present invention.

FIG. 6 is a flow diagram of a preferred embodiment of the method of FIG. 5.

FIG. 7 is a flow diagram of another preferred embodiment of the method of FIG. 5.

FIG. 8 is a flow diagram of another parallel chain cross-chain transaction method according to an embodiment of the present invention.

FIG. 9 is a composition diagram of a device according to an embodiment of the present invention.

### DETAILED DESCRIPTION OF THE PREFERRED EMBODIMENT

The present application is described in further detail below in connection with the accompanying drawings and embodiments. It is to be understood that the specific embodiments described herein are for illustrative purposes only and shall not limit the present invention. It is also to be noted that, for ease of description, only portions that are relevant to the present invention to be described are shown in the accompanying drawings.

It should be noted that, without conflict, features in the present application and features in the embodiments may be combined with each other. The present application will now be described in detail with reference to the accompanying drawings.

The present invention provides a solution to perform a cross-chain transaction between a main chain and a parallel chain. According to the present invention, a main chain may have one or more parallel chains deployed therewith.

Each node of a parallel chain corresponds to a different main chain node, and can communicate with the corresponding main chain node, while the nodes of the parallel chain cannot communicate with each other.

The consensus mechanism of the parallel chain relies on the consensus of the main chain: several verification nodes (typically 3f+1 nodes, while f is a positive integer) are configured in the parallel chain. The verification nodes respectively package the block information of the block waiting for consensus and send the block information to the corresponding main chain node. The main chain node records the block information onto the main chain and verifies whether there are the consensus mechanism of the parallel chain is by means of consensus of the backbone: several verification nodes (typically 3F+1, F are positive integers) are configured in the parallel chain). The verification nodes respectively package the block information of the block to be consensus and send the block information to the corresponding main chain node. The main chain node records the block information onto the main chain and verifies whether block information of the quantity not less than the first threshold number in each block information are the same: if yes, the parallel chain block passes the consensus and configures the “commit” identifier for authentication for the parallel chain block.

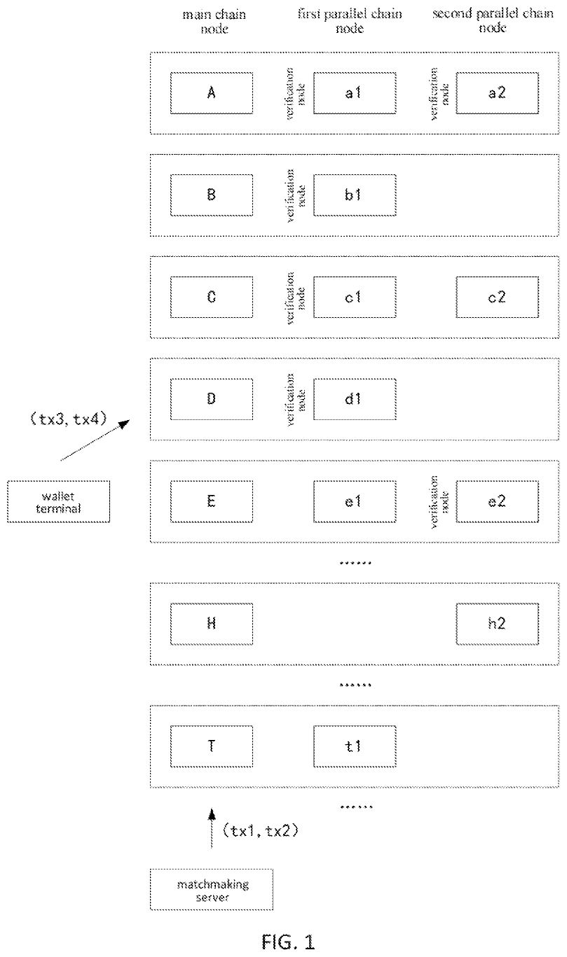

Solutions provided by the present invention are illustrated as follows along with FIGS. 1-8.

FIG. 1 is an application scenario view of a parallel chain cross-chain transaction according to an embodiment of the present invention. As illustrated in FIG. 1, according to the present embodiment, a main chain has several nodes (A, B, C, . . . T, . . . ) configured therein and the first parallel chain has 10 nodes (a1, b1, c1, . . . , t1) configured therein, wherein the cross-chain transaction solutions of the present invention will be illustrated with the examples that nodes a1, b1, c1, and d1 are configured as the verification nodes of the first parallel chain.

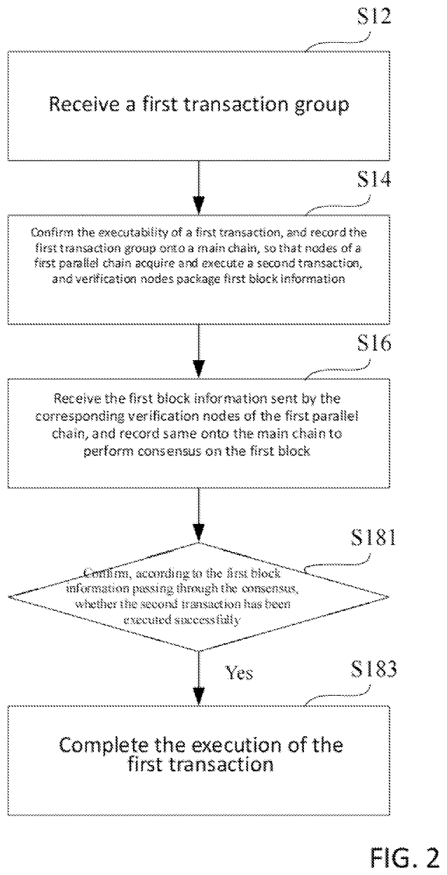

FIG. 2 is a flow diagram of a parallel chain cross-chain transaction method according to an embodiment of the present invention. As illustrated in FIG. 2, according to the present embodiment, the present invention provides a parallel chain cross-chain transaction method, adapted for a main chain node (such as the main chain node A/B/C/D as shown in FIG. 1) corresponding to a verification node of a parallel chain, comprising:

S12: receiving a first transaction group, wherein the first transaction group comprises a first transaction on a main chain and a second transaction on a first parallel chain, packaged and generated through a matchmaking server or a wallet terminal;

S14: confirming the executability of the first transaction and recording the first transaction group onto the main chain, so as for each of the nodes of the first parallel chain to respectively acquire and execute the second transaction from the corresponding main chain node and for each of the verification nodes of the first parallel chain to respectively package a first block information of a first block, wherein the first block information comprises the execution result of the second transaction;

S16: receiving the first block information sent by the corresponding verification nodes of the first parallel chain, and recording same onto the main chain to perform consensus, on the first block; and

S18: S181: confirming, according to the first block information of the first block passing through the consensus, whether the second transaction has been executed successfully: if yes, executing step S183: completing the execution of the first transaction.

Taking the scenario shown in FIG. 1 as an example, when user A desires to sell a certain membership on the main chain to exchange several moon cake credits on the first parallel chain, and issues a first transaction order and when user B wants to exchange the membership on the main chain with the quantity of moon cake credits on the first parallel chain, and issues a second transaction, the matching server makes a match to the two transaction orders, packages and generates a first transaction group (tx1, tx2), and sends the first transaction group (tx1, tx2) to the main chain node. Here, tx1 is the first transaction for the user A to transfer the membership to the user B on the main chain, and tx2 is the second transaction for the user B to pay a number of moon cake credits to the user A on the first parallel chain.

In the step S12, the main chain node A may directly receive the first transaction group (tx1, tx2) sent by the matchmaking server, and/or may receive the first transaction group (tx1, tx2) through synchronous communication with other main chain nodes.

In the step S14, the main chain node A confirms the executability of the first transaction tx1, which means to determine whether the user A has the membership that is transferable:

if the user A does not have the membership, or the membership cannot be transferred, then the first transaction tx1 cannot be executed and the subsequent step will be ceased;

if it is confirmed that the first transaction tx1 is executable, the first transaction group (tx1, tx2) will be recorded onto the main chain through the main chain consensus.

After the first transaction group (tx1, tx2) is recorded on the main chain, each node of the first parallel chain can obtain and execute the second transaction tx2 from the corresponding main chain node, respectively. For example, node a1 acquires tx2 from node A and executes, node b1 acquires tx2 from node B and executes, and so on.

Here, each of the verification nodes a1, b1, c1, d1 of the first parallel chain respectively sends the first block information of the first block, block p, to be consensus with the execution results of the tx2 packaged to the corresponding main chain nodes A, B, C, D respectively after performing the tx2.

In the step S16, main chain node A, B, C, and D respectively receive the first block information Blockₚ₋ₐ₁, Block_{p-b1}, Block_{p-c1}, and Block_{p-D1} sent by each of the verification nodes a1, b1, c1, and D1 of the first parallel chain, and record the first block information Blockₚ₋ₐ₁, Block_{p-b1}, Block_{p-c1}, Block_{p-d1} on the main chain through the consensus mechanism of the main chain; it is determined whether not less than a first threshold value (the quantity is configured as 3 for this embodiment) of all the first block information are consistent to each other, wherein if, for example, at least three of the first block information Blockₚ₋ₐ₁, Block_{p-b1}, Block_{p-c1}, Block_{p-d1} are the same, the parallel block, Blockₚ, passes a consensus; otherwise, the consensus is not passed.

In the step S18, the main chain node A confirms whether tx2 is successfully executed according to the execution result of the tx2 recorded in the block information of Block p of the parallel chain block that has passed the consensus:

if the execution fails, that is, the user B does not pay the number of moon cake credits to the user A on the first parallel chain, then tx1 will not be executed;

if the execution succeeds, it is shown that the user B has paid the number of moon cake credits to the user A on the first parallel chain, then tx1 will be executed to transfer the membership of the user A to the user B on the main chain.

The method illustrated in FIG. 2 is illustrated in an exemplar manner through the above embodiment that applies the example as illustrated in the scenario of FIG. 1 that the user A and the user B make a transaction for membership and mooncake credit and the cross-chain transactions are matched by a matching server. According to more embodiments, the method as shown in FIG. 2 may also be applied to any blockchain system employing the main chain-parallel chain architecture of the parallel chain consensus mechanism described above, which can be applied to any cross-chain transaction of the chain asset or non-asset on the chain, and the same technical effects may also be achieved through matching and packaging by the wallet terminal of the user to send the first transaction group.

The above embodiments provide a secure and reliable cross-chain transaction mechanism adapted for the main chain and the parallel chain through packaging a first transaction on a main chain and a second transaction on a parallel chain into a transaction group and send it to a main chain node and execute the second transaction on the parallel chain after the executability of the first transaction is confirmed, so as to utilize the consensus mechanism of the parallel chain to confirm the successful execution of the second transaction and then complete the execution of the first transaction on the main chain.

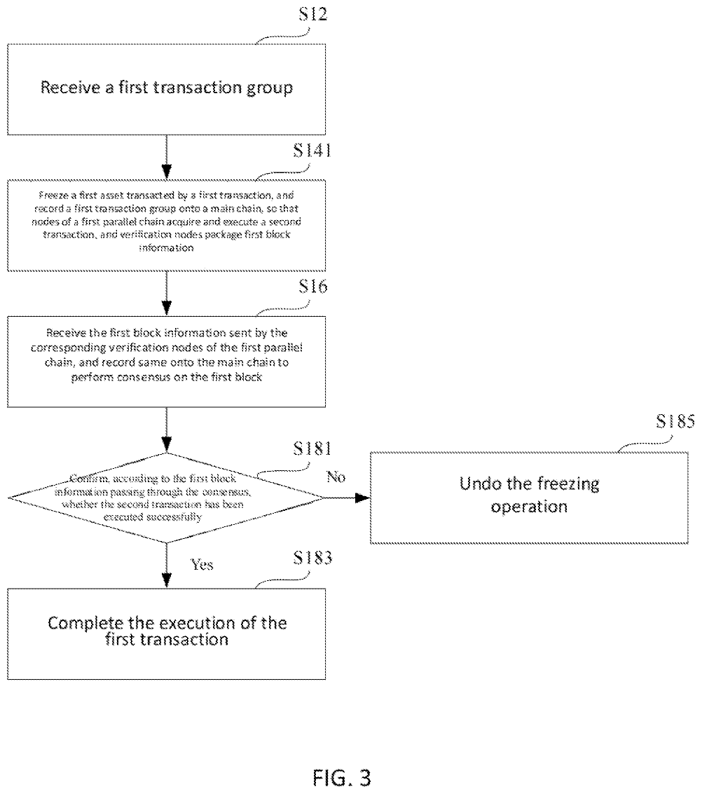

FIG. 3 is a flow diagram of a preferred embodiment of the method as shown in FIG. 2. Referring to FIG. 3, according to a preferred embodiment, the step S14 comprises:

S141: freezing the first asset of the first transaction and recording the first transaction group onto the main chain, so as for each of the nodes of the first parallel chain to respectively acquire and execute the second transaction from the corresponding main chain node and for each of the verification nodes of the first parallel chain to respectively package a first block information of a first block.

The step S18 also comprises:

S185: undoing the freezing operation when confirming the failure of the execution of the second transaction.

Specifically, in the scenario shown in FIG. 1, for the example that when the user C and the user D reach an agreement that exchange 10 XXX coins on the main chain of the user C with 100 YYY coins on the first parallel chain of the user D, the wallet terminal of the user C can generate a two-dimension code by scanning the wallet terminal of user D, or receive a signature order sent by the wallet terminal of user D, and package and generate a second transaction group (tx3,tx4), wherein tx3 is the third transaction where the user C pays 10 XXX coins to the user D on the main chain, and tx4 is the fourth transaction where the user D pays 100 YYY coins to the user C in the first parallel chain.

The principles of the cross-chain transaction method illustrated in FIG. 3 is the same as it of FIG. 2, except for:

In step S141, the node A not only needs to confirm that there are 10 XXX coins in the account of the user C, but also freeze the 10 XXX coins that was payable, so as to prevent the 10 XXX coins from being transferred or paid out by the user C for other payments before actually paid to the user D.

In step S185, when node A confirms that tx4 has failed, the 10 XXX coins in the user C account will be unfrozen.

The above embodiment illustrates an exemplary description of the method of FIG. 3 by using cross-chain transactions of encrypted currency as an example, and according to some other embodiments, the method illustrated in FIG. 3 may also be applied to cross-chain transactions of any different type of on-chain asset, which may achieve the same technical effects as well.

According to the above embodiment, it further freezes the asset transacted by the first transaction in advance and complete the execution of the first transaction after the second transaction is successfully executed, or undo the freezing operation after the execution of the second transaction has failed, thereby ensuring the atomicity of the asset type cross-chain transaction.

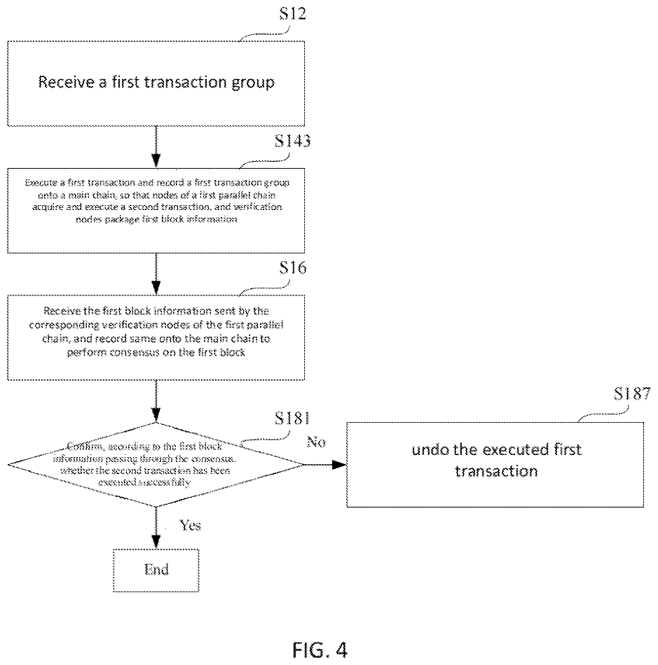

FIG. 4 is a flow diagram of another preferred embodiment of the method as shown in FIG. 2. Referring to FIG. 4, according to another preferred embodiment, the step S14 comprises:

S143: executing the first transaction and recording the first transaction group onto the main chain, so as for each of the nodes of the first parallel chain to respectively acquire and execute the second transaction from the corresponding main chain node and for each of the verification nodes of the first parallel chain to respectively package a first block information of a first block.

The step S18 also comprises:

S187: undoing the executed first transaction when confirming the failure of the execution of the second transaction.

The principles of the cross-chain transaction method as illustrated in FIG. 4 is mainly the same as it of FIG. 2, except for that the first transaction is performed first, and the undoing is performed after confirming that the second transaction is failed, so as to further ensure the atomicity of the cross-chain transaction.

The above embodiment further executes the first transaction on the main chain beforehand and undo the pre-executed first transaction when the execution of the second transaction has failed, so as to ensure the atomicity of the cross-chain transaction with the undoable main chain transaction.

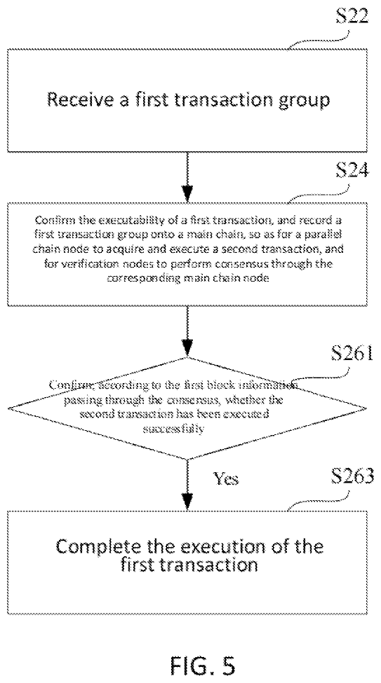

FIG. 5 is a flow diagram of another parallel chain cross-chain transaction method according to one embodiment of the present invention. The method as illustrated in FIG. 5 may be performed in conjunction with the method as illustrated in FIG. 2.

As illustrated in FIG. 5, according to the present embodiment, the present invention provides a parallel chain cross-chain transaction method for a main chain node (such as the main chain node E/H/T and etc. as shown in FIG. 1) corresponding to a non-verification node of a parallel chain, comprising:

S22: receiving a first transaction group, wherein the first transaction group comprises a first transaction on a main chain and a second transaction on a first parallel chain, packaged and generated through a matchmaking server or a wallet terminal;

S24: confirming the executability of the first transaction and recording the first transaction group onto the main chain, so as for each of the nodes of the first parallel chain to respectively acquire and execute the second transaction from the corresponding main chain node and for each of the verification nodes of the first parallel chain to respectively package and send a first block information of a first block to the corresponding main chain node to record the first block information on the main chain for performing consensus to the first block, wherein the first block information comprises the execution result of the second transaction; and

S26: S261: confirming, according to the first block information of the first block passing through the consensus, whether the second transaction has been executed successfully: if yes, executing step S263: completing the execution of the first transaction.

Specifically, the cross-chain transaction principle of the method as illustrated in FIG. 5 is basically the same as the method illustrated in FIG. 2, except that the parallel chain node corresponding to the main chain node of the method illustrated in FIG. 5 is not a verification node, so that the first block information sent by the corresponding parallel chain node will not be received, but coordinate with the consensus execution along with the first block information by the main chain node as illustrated in the method of FIG. 2.

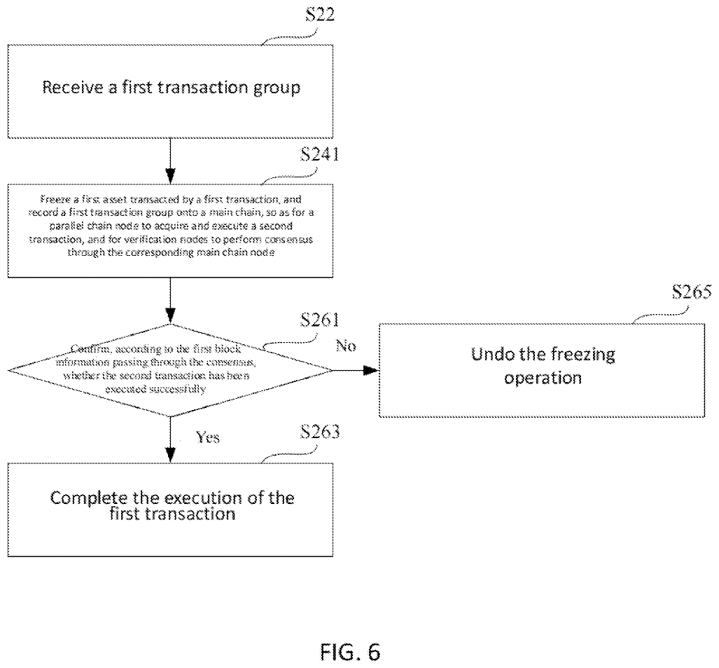

FIG. 6 is a flow diagram of a preferred embodiment of the method of FIG. 5. The method illustrated in FIG. 6 may be performed in conjunction with the method illustrated in FIG. 3.

Referring to FIG. 6, according to another preferred embodiment, the step S24 comprises:

S241: freezing the first asset transacted by the first transaction and recording the first transaction group onto the main chain, so as for each of the nodes of the first parallel chain to respectively acquire and execute the second transaction from the corresponding main chain node and for each of the verification nodes of the first parallel chain to respectively package and send a first block information of a first block to the corresponding main chain node to record the first block information on the main chain for performing consensus to the first block.

The step S26 also comprises:

S265: undoing the freezing operation when confirming the failure of the execution of the second transaction.

Specifically, the differences of the methods as illustrated in FIG. 6 and FIG. 3 are the same as the differences of the methods illustrated in FIG. 5 and FIG. 2, which will not be repeated here.

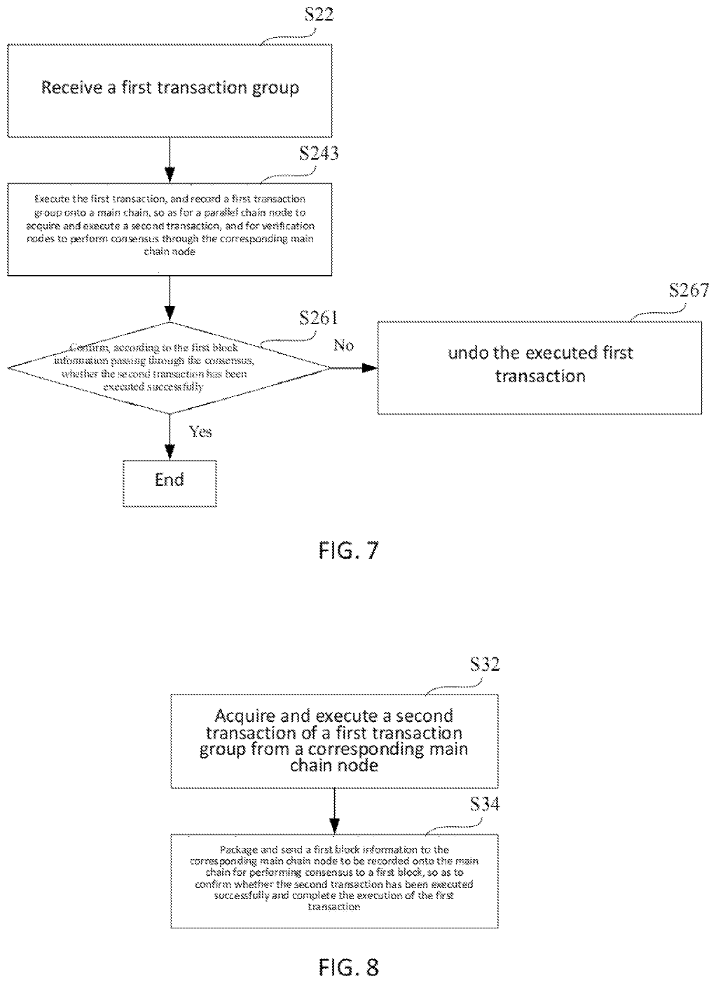

FIG. 7 is a flow diagram of another preferred embodiment of the method as shown in FIG. 5. The method as illustrated in FIG. 7 may be performed in conjunction with the method as illustrated in FIG. 4.

Referring to FIG. 7, according to another preferred embodiment, the step S24 comprises:

S243: executing the first transaction and recording the first transaction group onto the main chain, so as for each of the nodes of the first parallel chain to respectively acquire and execute the second transaction from the corresponding main chain node and for each of the verification nodes of the first parallel chain to respectively package and send a first block information of a first block to the corresponding main chain node to record the first block information on the main chain for performing consensus to the first block.

The step S26 also comprises:

S267: undoing the executed first transaction when confirming the failure of the execution of the second transaction.

Specifically, the differences of the methods as illustrated in FIG. 7 and FIG. 4 are the same as the differences of the methods as illustrated in FIG. 5 and FIG. 2, which will not be repeated here.

FIG. 8 is a flow diagram of another parallel chain cross-chain transaction method according to an embodiment of the present invention. The method illustrated in FIG. 8 may be performed in conjunction with the method illustrated in FIGS. 2-7.

As illustrated in FIG. 8, according to the present embodiment, the present invention provides a parallel chain cross-chain transaction method for verification nodes of a parallel chain (such as the verification nodes a1, b1, c1, d1 of the first parallel chain as illustrated in FIG. 1), comprising:

S32: acquiring and executing a second transaction of a first transaction group from the corresponding main chain node, wherein the first transaction group comprises a first transaction on the main chain and a second transaction on the first parallel chain, packaged and generated through a matchmaking server or a wallet terminal and sent to the main chain node, wherein the first transaction group is recorded onto the main chain when the main chain node received and confirmed the executability of the first transaction; and

S34: packaging and sending the first block information of the first block to the corresponding main chain node to be recorded onto the main chain for performing consensus to the first block, so as for the main chain node to confirm whether the second transaction is executed successfully based on the first block information of the first block with consensus: if yes, completing the execution of the first transaction. Here, the first block information comprises the execution result of the second transaction.

Preferably, the first asset transacted by the first transaction is frozen by the main chain node which received the first transaction group before the first transaction group is record onto the main chain and is undone when a main chain node confirms the failure of the execution of the second transaction.

Preferably, the first transaction is executed before the first transaction group is record onto the main chain by a main chain node and is undone when the main chain node confirms the failure of the execution of the second transaction.

Specifically, the principles of the cross-chain transaction method illustrated in FIG. 8 may be referred to it of FIGS. 2-7, which will not be repeated here.

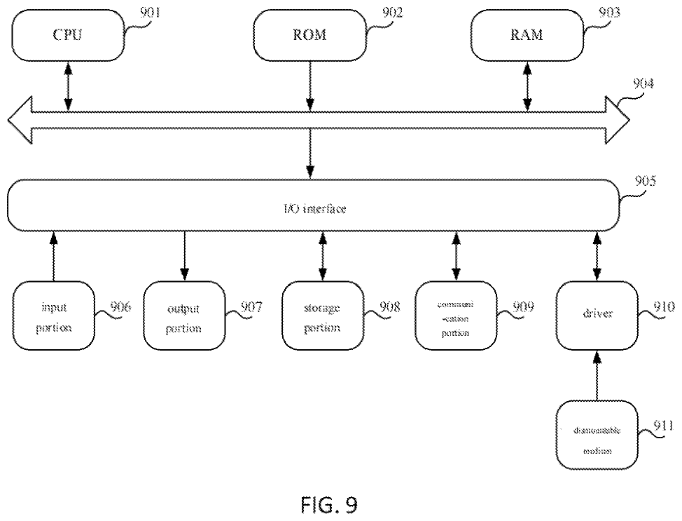

FIG. 9 is a composition diagram of a device according to one embodiment of the present invention.

Referring to FIG. 9, in another aspect, the present application also provides a device 900, which includes one or more central processing units (CPUs) 901 that can perform various suitable actions and processes in accordance with a program stored in a read-only memory (ROM) 902 or a program loaded into a random access memory (RAM) 903 from a storage portion 908. Various programs and data required for the operation of the device 900 are also stored in the RAM 903. The CPU 901, the ROM 902, and the RAM 903 are connected to each other via a bus 904. An input/output (I/O) interface 905 is also connected to the bus 904.

The following components are connected to the I/O interface 905: an input portion 906 including a keyboard, a mouse, and etc.; an output portion 907 including a cathode ray tube (CRT), a liquid crystal display (LCD), and etc., and a speaker and etc.; a storage portion 908 including a hard disk or the like; and a communication portion 909 including a network interface card, such as a LAN card, a modem, and etc. The communication portion 909 performs communication process via a network, such as the Internet. A driver 910 is also connected to the I/O interface 905 based on the needs. A removable media 911, such as magnetic disks, optical disks, magneto-optical disks, semiconductor memories, and etc., is mounted on the driver 910 based on the needs so that the computer programs read therefrom can be installed into the storage portion 908 as needed.

In particular, according to the embodiments of the present invention, the parallel chain cross-chain transaction method described in any of the above embodiments may be implemented as the computer program. For example, an embodiment of the present invention may provide a computer program product, which includes a computer program tangibly loaded on a machine-readable medium containing program code for performing a parallel chain cross-chain transaction method. According to such embodiment, the computer program may be downloaded and installed from the network through the communication portion 909 and/or installed from the removable medium 911.

As yet another aspect, the present application also provides a computer-readable storage medium, which may be a computer-readable storage medium included in a device of the above-described embodiments, or a computer-readable storage medium that may be provided separately, without being assembled in the device. The computer-readable storage medium stores one or more programs that are utilized by one or more processors to perform a parallel chain cross-chain transaction method disclosed in the present application.

The flow chart and block diagrams in the figures illustrate the constructions, functionality, and operation of possible implementations of the systems, methods, and computer program products according to various embodiments of the present invention. In this regard, each block in the flow chart or block diagrams may represent a module, segment, or portion of code, which includes one or more executable instructions for implementing the specified logical function(s). It should also be noted that, in some alternative implementations, the functions illustrated in the block may occur out of the order illustrated in the figures. For example, two blocks represented in succession may, in fact, be executed substantially concurrently, or the blocks may sometimes be executed in the reverse order, depending upon the functionality involved. It will also be noted that each block of the block diagrams and/or flow chart illustration, and combinations of the blocks in the block diagrams and/or flow chart illustration, may be implemented by special purpose hardware-based systems that perform the specified functions or acts, or combinations of special purpose hardware and computer instructions.

The units or modules described in the embodiments of the present application may be implemented in a software manner, or may be implemented in a hardware manner. The described units or modules may also be provided in a processor, for example, each of which may be a software program disposed in a computer or a mobile smart device or a separately configured hardware device. The names of these units or modules, in some cases, do not constitute a definition of the unit or module itself.

The above description is merely preferred embodiment(s) of the present application and is intended to be illustrative of the principles of the application. It should be understood by those skilled in the art that the scope of the present invention referred to herein is not limited to the particular combination of the above-described technical features, but also to other technical solutions formed by any combination of the above-described technical features or the equivalent features thereof without departing from the concepts of the present application. For example, technical solutions that are formed through alternating or interchanging the features described above and the technical features disclosed in this application (but are not limited to) with similar feature(s).

1-11. (canceled)

12. A parallel chain cross-chain transaction method, adapted for a main chain node corresponding to one of a plurality of verification nodes of each node of a first parallel chain, comprising the steps of:
(a) receiving a first transaction group, wherein the first transaction group comprises a first transaction on a main chain and a second transaction on the first parallel chain, packaged and generated through one of a matchmaking server and a wallet terminal;
(b) confirming an executability of the first transaction and recording the first transaction group onto the main chain, so as for each node of the first parallel chain to respectively acquire and execute the second transaction from the corresponding main chain node and for each of the plurality of verification nodes of the first parallel chain to respectively package a first block information of a first block, wherein the first block information comprises an execution result of the second transaction;
(c) receiving the first block information sent by the corresponding verification nodes of the first parallel chain, and recording same onto the main chain to perform consensus on the first block; and
(d) confirming, according to the first block information of the first block passing through the consensus, whether an execution of the second transaction has been executed successfully: if yes, completing an execution of the first transaction.

13. The parallel chain-cross transaction method, as recited in claim 12, wherein the confirming step (d) comprises:
freezing the first asset transacted by the first transaction; and
confirming, according to the first block information of the first block passing through the consensus, whether the second transaction has been executed successfully: if yes, the completion of the execution of the first transaction further comprising:
undoing the freezing of the first asset when confirming a failure of the execution of the second transaction.

14. The parallel chain-cross transaction method, as recited in claim 12, wherein the confirming step (d) comprises:
executing the first transaction;
confirming, according to the first block information of the first block passing through the consensus, whether an execution of the second transaction has been executed successfully: if yes, the completion of the execution of the first transaction further comprising:
undoing the executed first transaction when confirming a failure of the execution of the second transaction.

15. The parallel chain cross-chain transaction method, as recited in claim 12, wherein the parallel chain cross-chain transaction method is executed by a device which comprises one or more processors and a storage medium storing one or more programs, such that when the one or more programs are executed by the one or more processors, the one or more processors are allowed to execute the step (a) to step (d).

16. The parallel chain cross-chain transaction method, as recited in claim 13, wherein the parallel chain cross-chain transaction method is executed by a device which comprises one or more processors and a storage medium storing one or more programs, such that when the one or more programs are executed by the one or more processors, the one or more processors are allowed to execute the step (a) to step (d).

17. The parallel chain cross-chain transaction method, as recited in claim 14, wherein the parallel chain cross-chain transaction method is executed by a device which comprises one or more processors and a storage medium storing one or more programs, such that when the one or more programs are executed by the one or more processors, the one or more processors are allowed to execute the step (a) to step (d).

18. A parallel chain cross-chain transaction method, adapted for a main chain node corresponding to a non-verification node of a plurality of verification nodes of each node of a first parallel chain, comprising the steps of:
(a) receiving a first transaction group, wherein the first transaction group comprises a first transaction on a main chain and a second transaction on the first parallel chain, packaged and generated through one of a matchmaking server and a wallet terminal;
(b) confirming an executability of the first transaction and recording the first transaction group onto the main chain, so as for each node of the first parallel chain to respectively acquire and execute the second transaction from the corresponding main chain node and for each of the plurality of verification nodes of the first parallel chain to respectively package and send a first block information of a first block to the corresponding main chain node to record the first block information on the main chain for performing consensus to the first block, wherein the first block information comprises an execution result of the second transaction; and
(c) confirming, according to the first block information of the first block passing through the consensus, whether an execution of the second transaction has been executed successfully: if yes, completing an execution of the first transaction.

19. The method, as recited in claim 18, wherein the confirming step (c) comprises:
freezing the first asset transacted by the first transaction; and
confirming, according to the first block information of the first block passing through the consensus, whether the second transaction has been executed successfully: if yes, the completion of the execution of the first transaction further comprising:
undoing the freezing of the first asset when confirming a failure of the execution of the second transaction.

20. The method, as recited in claim 18, wherein the confirming step (c) comprises:
executing the first transaction;
confirming, according to the first block information of the first block passing through the consensus, whether an execution of the second transaction has been executed successfully: if yes, the completion of the execution of the first transaction further comprising:
undoing the executed first transaction when confirming a failure of the execution of the second transaction.

21. The parallel chain cross-chain transaction method, as recited in claim 18, wherein the parallel chain cross-chain transaction method is executed by a device which comprises one or more processors and a storage medium storing one or more programs, such that when the one or more programs are executed by the one or more processors, the one or more processors are allowed to execute the step (a) to step (c).

22. The parallel chain cross-chain transaction method, as recited in claim 19, wherein the parallel chain cross-chain transaction method is executed by a device which comprises one or more processors and a storage medium storing one or more programs, such that when the one or more programs are executed by the one or more processors, the one or more processors are allowed to execute the step (a) to step (c).

23. The parallel chain cross-chain transaction method, as recited in claim 20, wherein the parallel chain cross-chain transaction method is executed by a device which comprises one or more processors and a storage medium storing one or more programs, such that when the one or more programs are executed by the one or more processors, the one or more processors are allowed to execute the step (a) to step (c).

24. A parallel chain cross-chain transaction method, adapted for a verification node of a first parallel chain, comprising the steps of:
(a) acquiring and executing a second transaction of a first transaction group from a main chain node correspondingly, wherein the first transaction group comprises a first transaction on a main chain and a second transaction on the first parallel chain, packaged and generated through one of a matchmaking server and a wallet terminal and sent to the main chain node, wherein the first transaction group is recorded onto the main chain when the main chain node received and confirmed an executability of the first transaction; and
(b) packaging and sending the first block information of the first block to the corresponding main chain node to be recorded onto the main chain for performing consensus to the first block, so as for the main chain node to confirm whether an execution of the second transaction is executed successfully based on the first block information of the first block with consensus: if yes, completing an execution of the first transaction, wherein the first block information comprises an execution result of the second transaction.

25. The parallel chain cross-chain transaction method, as recited in claim 24, wherein the first asset transacted by the first transaction is frozen by the main chain node which received the first transaction group before the first transaction group is recorded onto the main chain and a freezing of the first asset is undone when the main chain node confirms a failure of the execution of the second transaction.

26. The parallel chain cross-chain transaction method, as recited in claim 24, wherein the first transaction is executed through the main chain node before the first transaction group is recorded onto the main chain and the execution result of the first transaction is undone when the main chain node is utilized to confirm a failure of the execution of the second transaction.

27. The parallel chain cross-chain transaction method, as recited in claim 24, wherein the parallel chain cross-chain transaction method is executed by a device which comprises one or more processors and a storage medium storing one or more programs, such that when the one or more programs are executed by the one or more processors, the one or more processors are allowed to execute the step (a) to step (b).

28. The parallel chain cross-chain transaction method, as recited in claim 25, wherein the parallel chain cross-chain transaction method is executed by a device which comprises one or more processors and a storage medium storing one or more programs, such that when the one or more programs are executed by the one or more processors, the one or more processors are allowed to execute the step (a) to step (b).

29. The parallel chain cross-chain transaction method, as recited in claim 26, wherein the parallel chain cross-chain transaction method is executed by a device which comprises one or more processors and a storage medium storing one or more programs, such that when the one or more programs are executed by the one or more processors, the one or more processors are allowed to execute the step (a) to step (b).
